(19) United States
(12) Patent Application Publication
(10) Pub. No.: US 2007/0092257 A1
(43) Pub. Date: Apr. 26, 2007

(54) Optical interface for communicating optical transceiver status information

(76) Inventors: Dale Trenton Smith, San Jose, CA (US); Greta L. Light, San Mateo, CA (US); James D. McVey, Palo Alto, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/256,506

(22) Filed: Oct. 21, 2005

(51) Int. Cl. H04B 10/00

(52) U.S. Cl. 398/135

(57) ABSTRACT

An optoelectronic transceiver includes a laser transmitter, a photodiode receiver, an optical transmitter, and circuitry. The circuitry includes memory, which includes one or more memory arrays for storing information related to the transceiver. The circuitry also includes analog to digital conversion circuitry for receiving a plurality of analog signals from the laser transmitter and photodiode receiver, converting the received analog signals into digital values, and storing the digital values in predefined locations within the memory. The circuitry further includes a status transmitter for reading from the memory and transmitting via the optical transmitter transceiver status information corresponding to a plurality of the digital values stored in the memory.

### TECHNICAL FIELD

The disclosed embodiments relate generally to the field of fiber optics transceivers and particularly to circuits used within the transceivers to accomplish control, setup, monitoring, and identification operations.

### BACKGROUND

The SFF-8472, XFP and DWDM standards provide mechanisms for monitoring the internal status of optoelectronic transceivers. These standards require both an electrical and mechanical connection to a transceiver to receive status information from the transceiver. In some contexts, users may want to check or monitor the status of a transceiver, or a set of transceivers, without having to form an electrical and mechanical connection to the transceiver.

### SUMMARY

In one embodiment, there is provided an optoelectronic transceiver, including a laser transmitter, a photodiode receiver, an optical transmitter, and circuitry. The circuitry includes memory, which includes one or more memory arrays for storing information related to the transceiver. The circuitry also includes analog to digital conversion circuitry for receiving a plurality of analog signals from the laser transmitter and photodiode receiver, converting the received analog signals into digital values, and storing the digital values in predefined locations within the memory. The circuitry further includes a status transmitter for reading from the memory and transmitting via the optical transmitter transceiver status information corresponding to a plurality of the digital values stored in the memory.

In another embodiment, there is provided a portable status monitor including an optical receiver, a visual interface and circuitry. The optical receiver receives optical signals containing status information from a transceiver. The circuitry includes memory, which includes one or more memory arrays for storing information related to the status monitor. The circuitry also includes circuitry for receiving a plurality of signals from the optical receiver converting the received signals into digital values, and storing the digital values in predefined locations within the memory. The circuitry further includes a processor for reading from the memory and displaying via the visual interface transceiver status information corresponding to a plurality of the digital values stored in the memory, wherein the transceiver status information includes information associated with an operating condition of the transceiver selected from the set consisting of a power supply voltage level, a bias current level, a received optical power level, a transmitter output power level, an internal temperature.

In some embodiments, the digital values include a flag value associated with an operating condition of the transceiver, and the displayed transceiver status information includes information corresponding to the flag value.

In some embodiments, the digital values include a plurality of flag values associated with at least one operating condition of the transceiver, and the displayed transceiver status information includes information corresponding to at least one of the flag values.

### BRIEF DESCRIPTION OF THE DRAWINGS

FIG. 1 is a block diagram of an optoelectronic transceiver according to one embodiment of the present invention.

FIG. 2 is a memory map for the transceiver controller and status monitor.

FIG. 3 is a flow diagram illustrating the method of transmitting status information.

FIG. 4 is a diagram of a portable status monitor.

FIG. 5 is a flow diagram illustrating the method of receiving and reading status information as performed by a portable status monitor.

FIG. 6 is a block diagram of the relationship between an optoelectronic transceiver and portable status monitor according to another embodiment of the present invention.

Like reference numerals refer to corresponding parts throughout the drawings.

### DESCRIPTION OF EMBODIMENTS

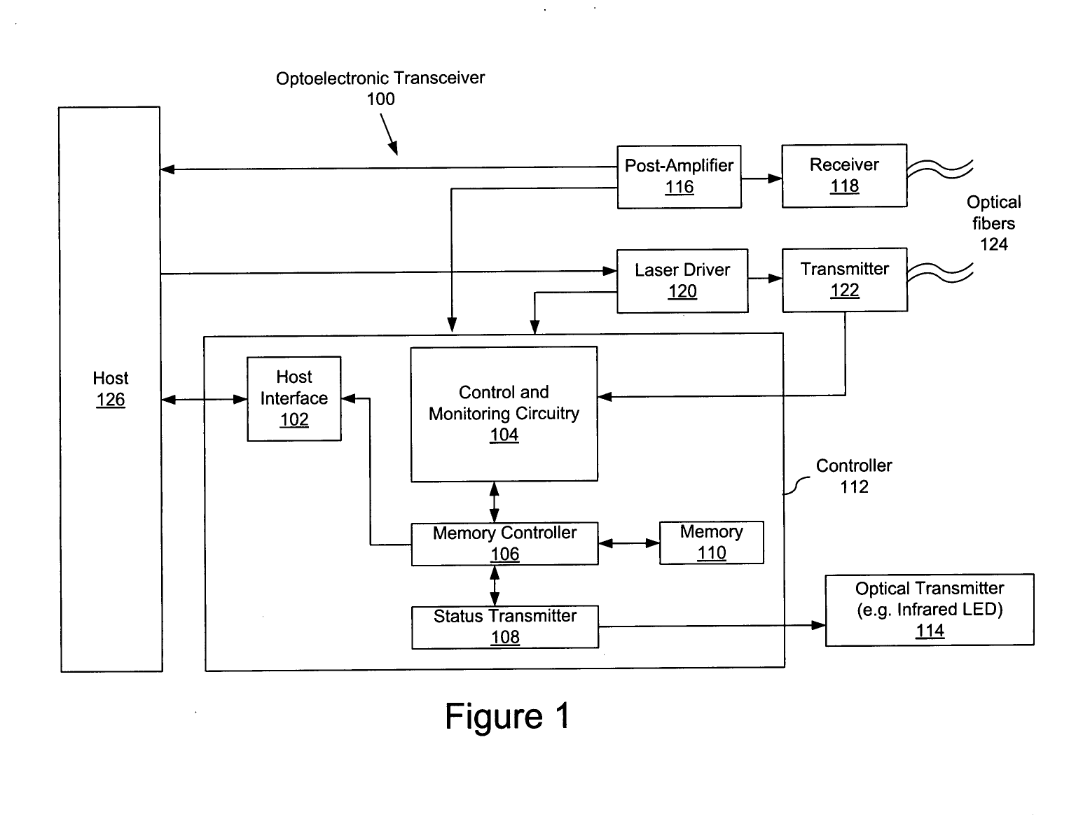

FIG. 1 is a block diagram of an optoelectronic transceiver 100 according to one embodiment of the present invention. The transceiver 100 includes a laser transmitter 122, laser driver 120, photodiode receiver 118, and post-amplifier 116. The transceiver 100 also includes a controller 112. Within the controller 112, there is control and monitoring circuitry 104, a memory controller 106, memory 110, and a status transmitter 108, and a host interface 102, which is connected to a host 126. The host 126 is a device or computer external to the transmitter 108 and its controller 106. Memory 110 includes one or more memory arrays for storing information related to the transceiver 100. The status transmitter 108 reads status information from the memory 110 and transmits the status information through the optical transmitter 114, which may be an infrared light transmitter, such as infrared light-emitting diode (LED). The status information corresponds to a plurality of the digital values stored in the memory 110. The status information includes information associated with one or more operating conditions of the transceiver. The operating conditions may include one or more of the following: a power supply voltage, a bias current level,. a received optical power level, a transmitter output power level, or an internal temperature. In some embodiments, the status information also includes identifying information (e.g., a serial number or other identifier), which identifies the transceiver 100.

In some embodiments, the transceiver 100 includes comparison logic for comparing digital values with limit values to generate flag values. The flag values may be stored in predefined locations within the memory 110 during the operation of the optoelectronic transceiver 100. The status transmitter 108 may be configured to read from the memory 110 and transmit via the optical transmitter 114 transceiver information corresponding to a plurality of the flag values stored in memory 110.

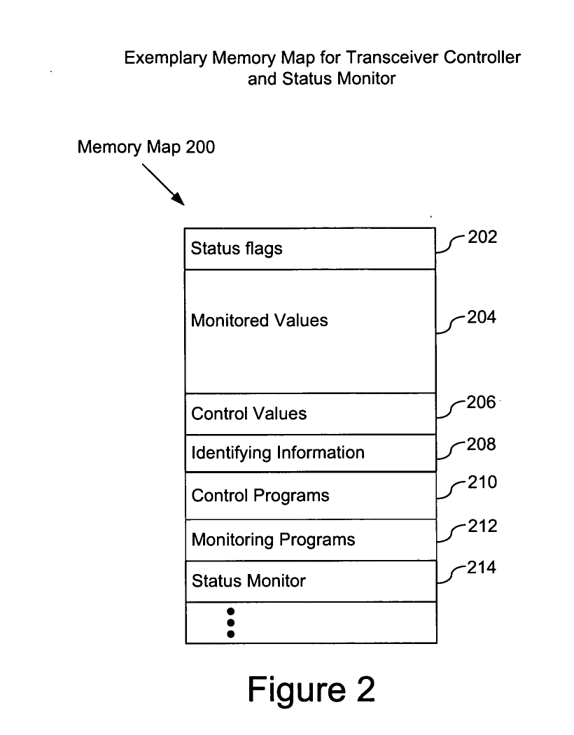

FIG. 2 is a block diagram further illustrating a memory map 200 for the transceiver controller and status monitor. Referring to this figure, in some embodiments the memory 110 stores the following programs, modules and data structures, or a subset thereof:
status flags 202;
monitored values 204;
control values 206;
identifying information 208;
control programs 210;
monitoring programs 212; and
status monitor 214.

Status flags 202 may include comparisons of operating conditions with warning alarms. In some embodiments, status flags 202 may include low and high level alarm flags.

Monitored values 204 may include values associated with an operating condition of the transceiver, such as a power supply voltage level, a bias current level, a received optical power level, a transmitter output power level, an internal temperature.

Control values 206 may include values associated with controlling the operation of the fiber optics transceiver.

Identifying information 208 may include information identifying the transceiver, such as the serial number of the transceiver or other types of identifiers.

In some embodiments where a microprocessor is used, the memory may include control programs 210, monitoring programs 212, and status monitor 214. Control programs 210 may include programs used in the operation of the laser transmitter and photodiode receiver.

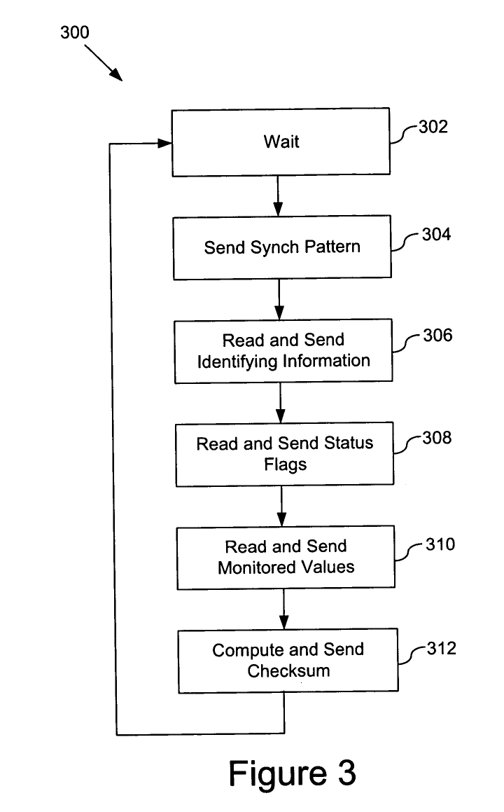

FIG. 3 is a flow diagram illustrating a method 300 for transmitting status information according to one embodiment of the invention. According to the method 300, a transceiver periodically transmits a “packet” of status information. The status information may be transmitted via an optical transmitter 114, as shown in FIG. 1. The method may be repeated at any suitable rate. In some embodiments, the repeat rate is between 0.5 and 20 times per second. In an exemplary embodiment, the repeat rate is between two and ten times per second.

After a predefined wait period 302, the process 300 begins. The transceiver first sends out a synch pattern 304 to the portable status monitor. Information identifying the transceiver is then read and sent 306. Status flags are also read and sent 308. The transceiver then reads and sends monitored values 310. A checksum for purposes of validation is then computed and sent 312. In some embodiments, the checksum of each status information packet is a function of the data in the status information packet, e.g., the status flags, the information identifying the transceiver and the monitored values. The checksum value may be a cyclic redundancy check (CRC) checksum, generated using a predefined polynomial function (e.g., the well-known 32-bit Ethernet CRC polynomial) or any other suitable checksum function. After another wait period 302, the method 300 is repeated.

While the method 300 includes a number of operations that appear to occur in a specific order, it should be apparent that the method can include more or fewer operations, an order of two or more operations may be changed, and/or two or more of the operations may be combined into a single operation. For instance, the order of operations 306, 308 and 310 may be changed. Similarly, in some embodiments, operation 308 or 310 or both may be omitted.

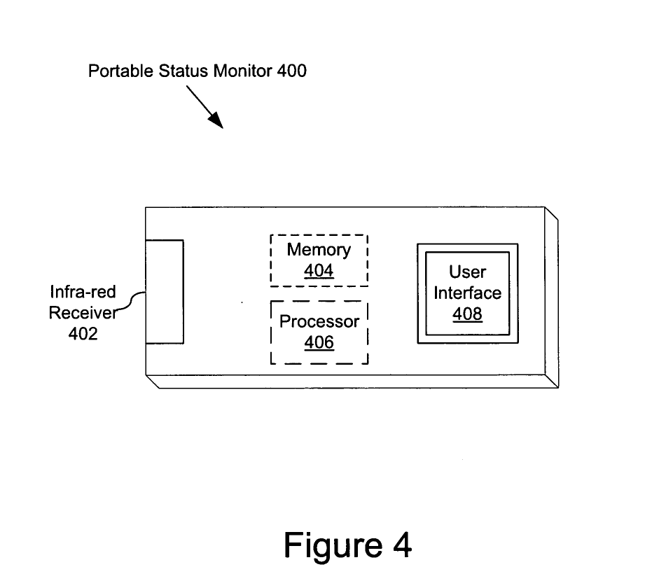

FIG. 4 is a diagram of a portable status monitor 400 according to one embodiment. The portable status monitor 400 includes an infra-red receiver 402, memory 404, processor 406 and user interface 408. The user interface 408 may include a graphical display to indicate a warning or alarm condition. The graphical display may also be used to display other information, such as transceiver identifying information and/or monitored values from a transceiver. The user interface 408 may also include a key pad with one or more buttons or a touch screen to enable user input when retrieving displayed information. For instance, a key pad or touch screen may be used to select what information to display, or to scroll through the information transmitted by a transceiver.

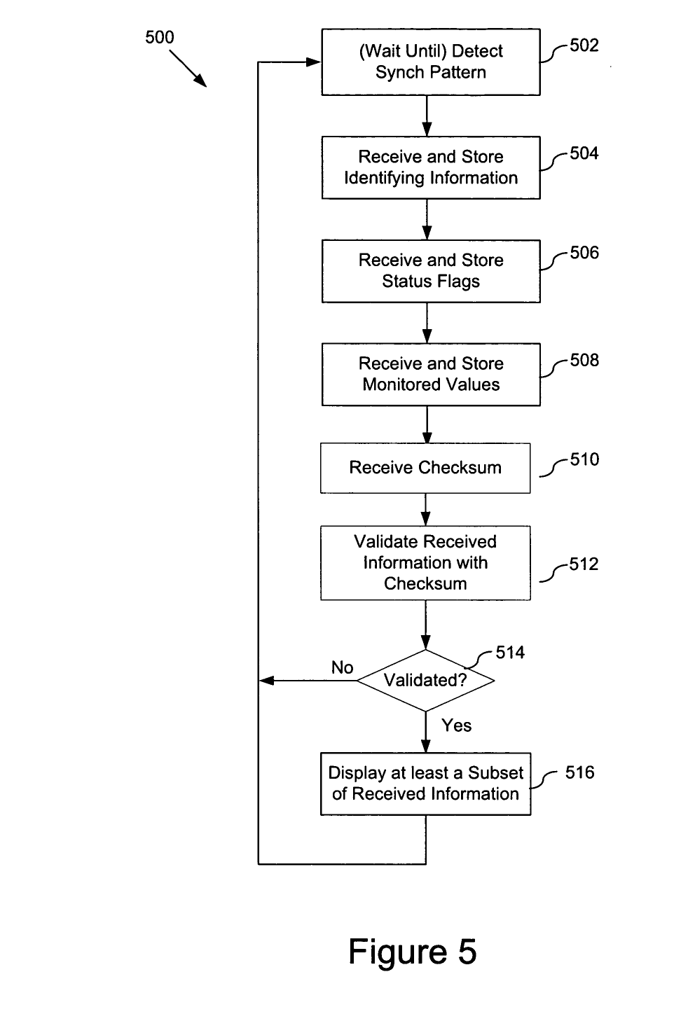

FIG. 5 is a flow diagram illustrating a method 500 of receiving and reading status information as performed by a portable status monitor. The portable status monitor waits until it detects a synch pattern 502, which is sent from the status transmitter of a transceiver. It then receives and stores the information identifying the transceiver 504. It also receives and stores status flags 506 and monitored values 508 sent from the transceiver. The portable status monitor then receives a checksum 510 and validates the received information with the checksum 512. After successfully validating the received information (514-Yes), it displays at least a subset of the information received from the transceiver 516. If the validation fails (514-No), the received information may be discarded (not shown), and the portable status monitor waits to receive a next information status packet from the transceiver. The method 500 is then repeated after another synch pattern is detected 502.

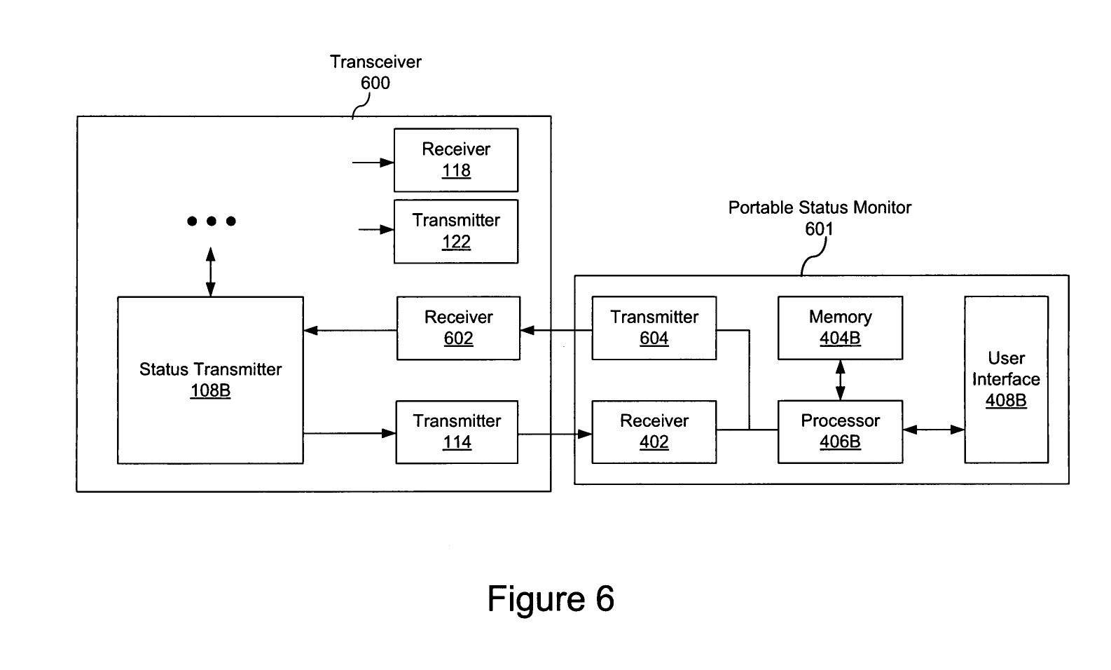

FIG. 6 is a block diagram of an optoelectronic transceiver 600 and portable status monitor 601 according to another embodiment of the present invention. The optoelectronic transceiver 600 differs from the optoelectronic transceiver 100 of FIG. 1 in that it includes an optical receiver 602 for receiving signals from the portable status monitor 601. Similarly, the portable status monitor 601 differs from the portable status monitor 400 of FIG. 4 in that it includes an optical transmitter 604 for sending signals to the transceiver 600. In some embodiments, the optoelectronic transceiver 600 sends information to the portable status monitor 601 in response to request signals from portable status monitor 601. For instance, the request signals may specify additional information requested by the portable status monitor 601 after receiving an initial set of information from the transceiver 600. In another example, the status transmitter 108B sends status information packets only in response to request signals received via the optical receiver 602. In some embodiments, memory 404B, processor 406B and user interface 408B may be configured to receive status information from the transmitter 122 of the transceiver automatically. In other embodiments, memory 404B, processor 406B and user interface 408B may be configured to receive status information from the transmitter 122 of the transceiver upon sending request signals to the receiver 118 of the transceiver.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An optoelectronic transceiver, comprising:
a laser transmitter
a photodiode receiver;
an optical transmitter; and
circuitry, comprising:
memory, including one or more memory arrays for storing information related to the transceiver;
analog to digital conversion circuitry for receiving a plurality of analog signals from the laser transmitter and photodiode receiver, converting the received analog signals into digital values, and storing the digital values in predefined locations within the memory; and
a status transmitter for reading from the memory and transmitting via the optical transmitter transceiver status information corresponding to a plurality of the digital values stored in the memory.

2. The optoelectronic transceiver of claim 1, including
comparison logic for comparing the digital values with limit values to generate flag values, wherein the flag values are stored in predefined locations within the memory during operation of the optoelectronic transceiver;
wherein the status transmitter is configured to read from the memory and transmit via the optical transmitter transceiver information corresponding to a plurality of the flag values stored in the memory.

3. The optoelectronic transceiver of claim 1, wherein the optical transmitter is an infrared light transmitter.

4. The optoelectronic transceiver of claim 1, wherein the transceiver status information includes information associated with an operating condition of the transceiver selected from the set consisting of a power supply voltage level, a bias current level, a received optical power level, a transmitter output power level, an internal temperature.

5. The optoelectronic transceiver of claim 1, wherein the status transmitter periodically repeats the reading and transmitting.

6. The optoelectronic transceiver of claim 1, further including an optical receiver;
wherein the status transmitter is configured to perform the reading and transmitting in response to a signal from the optical receiver.

7. A method of operating an optoelectronic transceiver having a laser transmitter and a photodiode receiver, comprising:
receiving a plurality of analog signals from the laser transmitter and photodiode receiver, converting the received analog signals into digital values, and storing the digital values in predefined locations within a memory; and
reading from the memory and optically transmitting transceiver status information corresponding to a plurality of the digital values stored in the memory.

8. The method of claim 7, wherein optically transmitting the transceiver status information includes transmitting the transceiver status information via an optical transmitter that is distinct from the laser transmitter.

9. The method of claim 7, including
comparing the digital values with limit values to generate flag values, and storing the flag values in predefined locations within the memory during operation of the optoelectronic transceiver;
wherein the transceiver status information includes a plurality of the flag values.

10. The method of claim 7, wherein the transceiver status information includes information associated with an operating condition of the transceiver selected from the set consisting of a power supply voltage level, a bias current level, a received optical power level, a transmitter output power level, an internal temperature.

11. A portable status monitor, comprising:
an optical receiver for receiving optical signals containing status information from a transceiver;
a user interface; and
circuitry, comprising:
memory, including one or more memory arrays for storing information related to the status monitor;
circuitry for receiving a plurality of signals from the optical receiver, converting the received signals into digital values, and storing the digital values in predefined locations within the memory; and
a processor for reading from the memory and displaying via the visual interface transceiver status information corresponding to a plurality of the digital values stored in the memory, wherein the transceiver status information includes information associated with an operating condition of the transceiver selected from the set consisting of a power supply voltage level, a bias current level, a received optical power level, a transmitter output power level, an internal temperature.

12. The portable status monitor of claim 11, wherein the transceiver status information includes information identifying the transceiver.

13. The portable status monitor of claim 11, wherein the digital values including a flag value associated with an operating condition of the transceiver, and the displayed transceiver status information includes information corresponding to the flag value.

14. The portable status monitor of claim 11, wherein the digital values including a plurality of flag values associated with at least one operating condition of the transceiver, and the displayed transceiver status information includes information corresponding to at least one the flag values.

15. The portable status monitor of claim 11, wherein the digital values including a plurality of flag values associated with at least one operating condition of the transceiver, and the displayed transceiver status information includes information corresponding to at least two of the flag values.

16. The portable status monitor of claim 11, wherein the optical receiver is an infrared light receiver.

17. A method of operating a portable status monitor, comprising:
receiving a plurality of optical signals containing status information from a transceiver;
converting the received optical signals into digital values;
storing the digital values in predefined locations within a memory; and
displaying transceiver status information corresponding to a plurality of the digital values stored in the memory, wherein the transceiver status information includes information associated with an operating condition of the transceiver selected from the set consisting of a power supply voltage level, a bias current level, a received optical power level, a transmitter output power level, an internal temperature.

18. The method of claim 17, wherein the digital values including a flag value associated with an operating condition of the transceiver, and the displayed transceiver status information includes information corresponding to the flag value.

19. The method of claim 17, wherein the digital values including a plurality of flag values associated with at least one operating condition of the transceiver, and the displayed transceiver status information includes information corresponding to at least one the flag values.

20. The method of claim 17, wherein the digital values including a plurality of flag values associated with at least one operating condition of the transceiver, and the displayed transceiver status information includes information corresponding to at least two of the flag values.

21. The method of claim 17, wherein the transceiver status information includes information identifying the transceiver.

22. The method of claim 17, wherein the received optical signals are infrared light signals.
